(19) United States
(12) Patent Application Publication
(10) Pub. No.: US 2023/0083013 A1
(43) Pub. Date: Mar. 16, 2023

(54) SYSTEM AND PROCESS FOR MANUFACTURING INTEGRATED ROOF SYSTEM WITH ENGINEERED WOOD

(71) Applicant: LOUISIANA-PACIFIC CORPORATION, NASHVILLE, TN (US)

(72) Inventors: JARROD KEVIN LINE, NASHVILLE, TN (US); LUKE MICHAS, NASHVILLE, TN (US); SARATH VEGA-GUTIERREZ, NASHVILLE, TN (US); FELICIA FANCHER, NASHVILLE, TN (US); RYLIE BARLING, NASHVILLE, TN (US); WILLIAM H. BAIRD, NASHVILLE, TN (US); QINING SUN, NASHVILLE, TN (US)

(21) Appl. No.: 17/944,933

(22) Filed: Sep. 14, 2022

Related U.S. Application Data
(60) Provisional application No. 63/243,806, filed on Sep. 14, 2021.

(51) Int. Cl. E04D 1/20

(52) U.S. Cl. CPC E04D 1/20

(57) ABSTRACT

A method to manufacture, on one or more production or manufacturing lines, an integrated roofing product, such as a roofing panel or roofing plank. A blank panel of engineered wood is cut or sawn into a plurality of raw planks or raw panels, each with an outer face, an inner face, a top edge, and a bottom edge. Each raw plank or panel is then processed by cutting or routing a profile into the top edge, the bottom edge, or both; affixing a gasket seal to the profile in the top edge or the bottom edge, or both; coating at least some or all of the outer face with a silicone-based or silicone-containing coating; applying a mix of granules and/or sand to the silicone-based coating while wet; and curing the coated plank or panel. A plurality of panels or planks can then be installed on a roofing structure.

This application claims benefit of and priority to U.S. Provisional App. No. 63/243,806, filed Sep. 14, 2021. U.S. Provisional App. No. 63/243,806 is incorporated herein in its entirety by specific reference for all purposes.

### FIELD OF INVENTION

This invention relates to a system and process for manufacturing multi-layered engineered roofing structural panels (which can be wood-based, such as, but not limited to, oriented-strand board (OSB), plywood, or other lignocellulosic-based panel), which may or may not have integrated ventilation and flashing.

### BACKGROUND OF THE INVENTION

Current roof assemblies are typically multiple layers of several materials, each performing a single function, that are installed separately on the site in which the building is being constructed. In many roofing systems, there is a deck, an underlayment barrier on top of the deck, covered by a surface layer of shingles (e.g., asphalt, ceramic, metal, and the like). Compatibility between the various layers creates challenges not only for the designer, but also for the installers. In addition, a varied and large amount of materials are required during the installation, as well as during maintenance (e.g., re-roofing).

A central layer in most such assembles in a wood panel product, or an integral composite engineered panel product, including, but not limited to, engineered wood composite products formed of lignocellulosic strands or wafers (sometimes referred to as oriented-strand board, or OSB). Products such as fiberboard and particleboard have been found to be acceptable alternatives in most cases to natural wood paneling, sheathing and decking lumber. Fiberboard and particleboard are produced from wood particles bonded together by an adhesive, the adhesive being selected according to the intended use of and the properties desired for the lumber. Often times, the adhesive is combined with other additives to impart additional properties to the lumber. Additives can include, but are not limited to, fire retardants, insect repellants, moisture resistant substances, fungicides and fungal resistant substances, and color dyes. A significant advantage of fiberboard and particleboard lumber products is that they have many of the properties of plywood, but can be made from lower grade wood species and waste from other wood product production, and can be formed into lumber in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

### SUMMARY OF INVENTION

In various exemplary embodiments, the present invention comprises a novel and unique process for manufacturing an integrated roofing panel coated with a silicone-based binder, or other form of binder, applied to portions, such as the top and sides, of the roof sheathing planks and/or panels.

In one embodiment, blank panels are manufactured and cut into multiple roofing planks or roofing panels (hereinafter referred to as “roofing planks” or “planks”). The size (e.g., length, width, thickness) and orientation of the planks may vary, depending on the particular end use. Each plank may be cut with a specific profile (e.g., standard plank, starter plank, crown plank, or other profiles), which can be applied to the roof of a structure (e.g., house or shed). Planks may be cut with one or more saws or other tools according to standard wood remanufacturing processes as known in the art. The number and orientation of the planks as cut may be based on the wood grain orientation in the panel. For example, the planks may be cut so that the wood grain orientation with respect to the long side of the panel is maintained with respect to the long side of the planks. The opposite orientation may be desired for some applications. Each blank is then subjected to further processing, as described below.

Next, the planks cut from the blank panels are coated with a silicone-based coating on one or more sides and/or edges. Uncoated planks are conveyed on a conveyor belt or line under a coating applicator or extruder. Silicone is a waterproof and durable material after it is applied, but the application of silicone is significantly different and more difficult in this process. In particular, the spray application of silicone, as is known in the art, is difficult in this manufacturing environment. Instead, in one embodiment of the present invention, the silicone is either curtain coated on the planks from the cut blank panel, or extruded (slot die) as a flat sheet, which is laid on the planks cut blank panel passing underneath the extruder on a processing line or belt. Excess silicone may be recycled and reused in the process.

After coating the planks from the cut blank panel with the silicone coating, aggregate, sand, granules, or similar texturizing material is applied to the outer or upper surface of the silicone on a plank. The aggregate, sand, granules or similar texturizing material provides an appealing surface texture, reduces gloss, and increases the grip or traction of the surface. The material may be applied with a feeder, a shaker, a vibratory applicator, or a screen applicator. In a preferred embodiment, fine grit sand or aggregate in a range between approximately 10 mesh to approximately 40 mesh is used for providing texture while remaining in the visible area of the surface.

After application of sand/aggregate, the coated planks are cured in a high humidity, moderate temperature oven. In one exemplary embodiment, the oven operates between 100-125 degrees F., and from 50 to 90% relative humidity. In order to prevent condensation on the surface of the silicone, the product may be heated during a warm-up period before high humidity is provided. If the relative humidity has to be below 95%, the warm-up period can be avoided. Curing time is approximately 10-45 minutes. In one embodiment, the curing time is approximately 30-45 minutes. Finally, the cured product is graded, packaged, stored and/or shipped. Typical processes known in the art for similar products may be used.

### BRIEF DESCRIPTION OF THE DRAWINGS

FIG. 1 shows a diagram of a production or assembly line process in accordance with an embodiment of the present invention.

FIG. 2 shows a diagram of an alternative production line process in accordance with another embodiment of the present invention.

### DETAILED DESCRIPTION OF EXEMPLARY EMBODIMENTS

Integrated roof sheathing, defined as the structural support for the exterior roof of a home, and weather barrier or roof covering has been combined into a single, integrated component, as described in U.S. patent application Ser. No. 17/200,648, filed Mar. 12, 2021, U.S. patent application Ser. No. 17/068,712, filed Oct. 12, 2020, U.S. patent application Ser. No. 17/685,048, filed Mar. 2, 2022, U.S. patent application Ser. No. 17/858,591, filed Jul. 6, 2022, U.S. Provisional App. No. 62/988,849, filed Mar. 12, 2020, U.S. Provisional App. No. 63/001,563, filed Mar. 30, 2020, U.S. Provisional App. No. 63/218,587, filed Jul. 6, 2021, and U.S. Provisional App. No. 63/155,343, filed Mar. 2, 2021; all of which are incorporated herein in their entireties by specific reference for all purposes.

These integrated multi-layers panel or plank are installed in one step rather than multiple steps for current roofing. The multi-layer integrated roofing product comprises a wood structural panel or plank 10. The wood may be natural or manufactured, engineered wood, such as oriented strand board (OSB) or plywood. The panel may be coated or treated, during or after the manufacturing process, with a product that provides various properties, such as, but not limited to, weather resistance, fungus resistance, insect resistance, and/or fire resistance. The treatment may be integrated with the material forming the wood structural panel, or may be a coating on one or both surfaces. An example of an integrated roofing panel is disclosed in U.S. patent application Ser. No. 17/068,712, filed Oct. 12, 2020 by Louisiana-Pacific Corp, which is incorporated herein in its entirety by specific reference for all purposes.

A weather or water resistive barrier (WRB) of some kind may be applied to the upper or outward facing surface of the panel, effectively serving as an underlayment. The WRB may be a form of paper overlay, a form of spray-applied or fluid-applied or extruded polymer or material (such as silicone), or other form of WRB. An example of a silicone-coated integrated roofing panel is disclosed in U.S. Provisional App. No. 63/155,343, filed Mar. 2, 2021, which is incorporated herein in its entirety by specific reference for all purposes. The invention thus effectively combines a structural sheathing panel, WRB layer or polymer, and texturizing aggregates or materials, if present (e.g., surface layer, shingles, metals, or other roof surface materials), as separately applied in the prior art, into one multi-layer panel product, which is less reliant on skilled labor for installation at a job site and reduces installation time by eliminating the separate sequential application of a WRB system and a surface layer in the installation process.

Several embodiments of a novel and unique process for manufacturing an integrated roofing panel coated with silicone (applied to portions, such as the top and sides, of the roof sheathing) are described below.

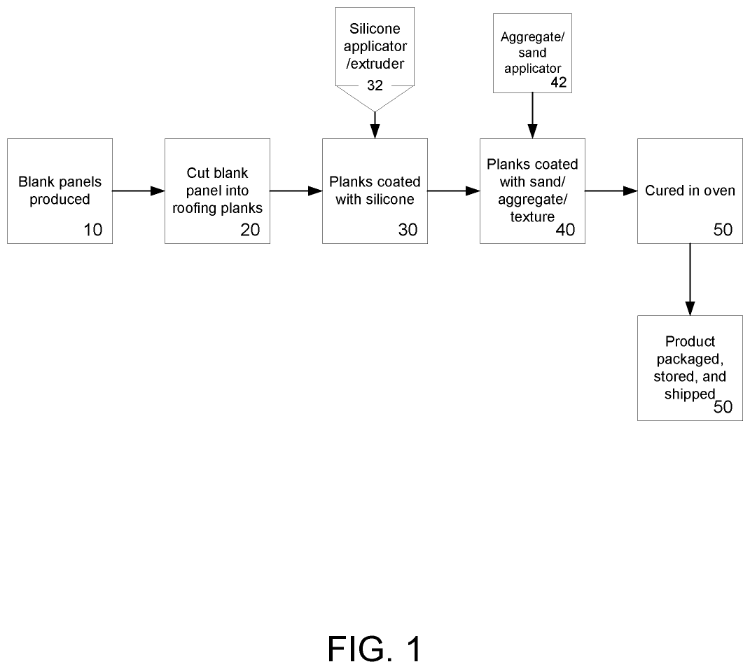

In the exemplary embodiments shown in FIG. 1, blank panels are manufactured 10. Blank panels are defined as uncut or oversized panels produced by an engineered wood manufacturing process, as described in the references above. Each blank is cut into multiple roofing planks or roofing panels (hereinafter referred to as “roofing planks” or “planks”) 20. The size (e.g., length, width, thickness) and orientation of the planks may vary, depending on the particular end use. Each plank may be cut with a specific profile (e.g., standard plank, starter plank, crown plank, or other profiles), which can be applied to the roof of a structure (e.g., house or shed). Planks may be cut with one or more saws or other tools according to standard wood remanufacturing processes as known in the art.

The number and orientation of the planks as cut may be based on the wood grain orientation in the panel. For example, the planks may be cut so that the wood grain orientation with respect to the long side of the panel is maintained with respect to the long side of the planks. The opposite orientation may be desired for some applications. Each blank is then subjected to further processing, as described below.

Next, the planks cut from the blank panels are coated with a silicone-based coating 30 on one or more sides and/or edges. Uncoated planks are conveyed on a conveyor belt or line under a coating applicator or extruder 32. Silicone is a waterproof and durable material after it is applied, but the application of silicone is significantly different and more difficult in this process. In particular, the spray application of silicone, as is known in the art, is difficult in this manufacturing environment. Instead, in one embodiment of the present invention, the silicone is either curtain coated on the planks from the cut blank panel, or extruded (slot die) as a flat sheet, which is laid on the planks cut from the blank panel passing underneath the extruder on a processing line or belt. Excess silicone may be recycled and reused in the process.

After coating the planks from the cut blank panel with silicone, aggregate, sand or similar texturizing material 40 is applied to the outer or upper surface of the silicone on the plank. The aggregate, sand or similar texturizing material provides an appealing surface texture, reduces gloss, and increases the grip or traction of the surface. The material may be applied with a feeder, a shaker, or a screen applicator 42. In a preferred embodiment, fine grit sand or aggregate in a range between approximately 10 mesh to approximately 40 mesh is used for providing texture while remaining in the visible area of the surface.

After application of sand/aggregate, the coated planks are cured in a high humidity, moderate temperature oven 50. In one exemplary embodiment, the oven operates between 100-125 degrees F., and from 50 to 90% relative humidity. In order to prevent condensation on the surface of the silicone, the product may be heated during a warm-up period before high humidity is provided. If the relative humidity has to be below 95%, the warm-up period can be avoided. Curing time is approximately 10-45 minutes. In one embodiment, the curing time is approximately 30-45 minutes.

Finally, the cured product is graded, packaged, stored and/or shipped 60. Typical processes known in the art for similar products may be used.

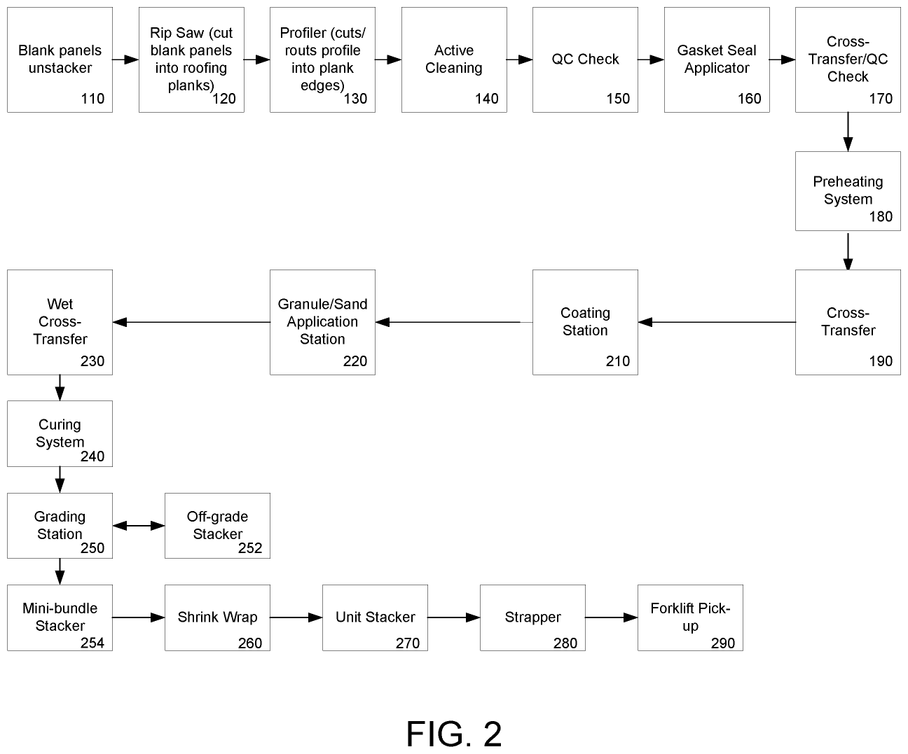

FIG. 2 shows a more detailed diagram of another embodiment of the present invention. Blank panels are delivered to the start of a production line, and are unstacked 110. A rip saw (or other saw) 120 is used to cut the blank panel in roofing planks or panels of desired dimensions, as described above. A profiler 130 is used to cut or rout a desired profile into the plank edges and/or sides. The profile may include, for example, a top edge underlap profile, a bottom edge underlap profile, a top edge profile for a crown plank, or a bottom angled drip edge profile for a starter plank. The planks are then cleaned 140, and undergo a quality control (QC) check 150. Planks that pass the QC check then have one or more gasket seals, such as D-gasket seals, affixed or adhere to appropriate locations (e.g., on the face of an underlap profile or the face of an overlap profile) 160. After a second quality control check, the planks are then cross-transferred 170 to a preheating system 180. The preheating system 180 heats the plank(s) in preparation for the coating process. Preheating may be provided by a heating lamp, heating tunnel, an oven, or similar means.

After preheating, the planks are cross-transferred 190 to a second production line for coating 210 and the addition of aggregate (e.g., granules, sand) 220. At the coating station 210, the planks are coated, as described above, with a silicone-based coating formulation on one or more sides and/or edges in a humidity-controlled environment. Coating techniques include, but are not limited to, curtain coating, spray coating, slot-die coating, extrusion coating, slide coating, rolling coating, and dip and brush conformal coating methods. These methods facilitate the application of binders in the coating on the engineered roofing structural panel.

Binders are a part of the coating's makeup as used in the present invention, and include organic polymers and/or inorganic geopolymers to hold the pigments or colorants in place and bind all the ingredients together to provide a coated roof system with excellent waterproofing and weatherproof properties. Organic polymers in the coating may comprise resins or adhesives, such as, but not limited to, epoxy, alkyd, acrylic, urethane, silicone, phenolic, silicone-epoxy hybrid resin, fluoropolymer, acrylic-fluoropolymer mixtures, and the like. Geopolymers in an inorganic binder system may comprises sodium silicate, potassium silicate, aluminosilicates, zinc phosphate, and similar materials. In several embodiments, the coating formulation may use a resin or adhesive other than a silicone resin.

Binder (e.g., silicone resin as applied here) may be supplied in totes, mixed before feeding, pumped to a day tank with mixing and heat blankets, and pumped to the coating station (e.g., curtain coater) with a recirculation pump. As discussed above, this binder preparation process should be enclosed in a humidity-controlled environment.

Various colorants added into or with binders provide coatings with excellent appearance, aesthetics and functionality. A non-limiting example is adding carbon black into the binder system to provide better hiding power, color stability, solvent resistance, abrasion resistance, acid and alkali resistance, as well as thermal stability.

After coating, an aggregate (e.g., granules, sand) is distributed on the binder surface by an applicator, such as a vibratory feeder 220. The granules or sand are mixed separately, and placed in a collection or supply bin. A screw feeder feeds the granules or sand to the vibratory feeder located above the plank(s). Excess granules or sand that do not adhere to the binder surface are collected and return conveyed to a collection bin, and may be reused.

Subsequently, the planks are wet cross-transferred 230 to a curing system 240 to cure the silicone-based coating. In general, the curing system comprises a humidity-controlled drying oven or light-based (e.g., UV ray) curing apparatus. Curing methods include thermal curing with heat, heating in conjunction with in-process adding or post-adding of curing agents and hardeners, visible light (e.g., ultraviolet (UV) rays in the 350-380 nm range), moisture curing (humidity and atmospheric curing), hybrid curing under heat at different levels of moisture, and similar techniques. The curing techniques used are dependent on the type of binder formulation and system used.

After curing, the planks are graded at a grading station 250. Planks that do not meet the grading standard (i.e., “off-grade”) are sent to an off-grade stacker 252 for later processing. Planks that meet the requisite grade are send to a mini-bundle stacker 254, where a suitable number of planks are bundled together in a stack. The stack is then shrink-wrapped 260, and sent to a unit stacker 270 where multiple shrink-wrapped bundles are combined to form a unit. The stacked bundles forming the unit are then strapped 280 together, and transported by a fork-lift or other transport machinery to a storage location for further processing and shipping.

It should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method to manufacture an integrated roofing product, comprising the steps of:
cutting a blank panel of engineered wood into a plurality of raw planks or raw panels, each with an outer face, an inner face, a top edge, and a bottom edge;
for each raw plank or panel:
cutting or routing a profile into the top edge, the bottom edge, or both;
affixing a gasket seal to the profile in the top edge or the bottom edge, or both;
coating at least some or all of the outer face with a silicone-based or silicone-containing coating;
applying a mix of granules and/or sand to the silicone-based coating while wet; and
curing the coated plank or panel.

2. The method of claim 1, further comprising the step of:
for each raw plank or panel, pre-heating the raw plank or panel prior to the step of coating.

3. The method of claim 2, wherein the step of pre-heating comprises the step of placing the raw plank or panel in a heating tunnel or oven.

4. The method of claim 1, wherein the step of coating comprises applying the coating using curtain coating.

5. The method of claim 1, wherein the step of coating comprises extruding the coating as a flat sheet, and placing the extruded sheet on the outer face.

6. The method of claim 1, wherein the step of curing comprises placing the coated plank or panel in a high humidity, moderate temperature oven.

7. The method of claim 6, further comprising the step of heating the coated plank or panel during a warm-up period before high humidity is applied.

8. The method of claim 1, wherein the step of applying a mix of granules and/or sand comprises the step of feeding the mix to a screen applicator.

9. The method of claim 8, wherein the granules and/or sand are sized in a range between approximately 10 mesh to approximately 40 mesh.

10. The method of claim 1, wherein mix of granules and/or sand are only applied to portions of the outer face that will not be covered by adjacent roofing products when installed on a roofing structure.

11. An integrated roofing plank or roofing panel produced according to the method of claim 1.
